(19) United States
(12) Patent Application Publication
(10) Pub. No.: US 2016/0139909 A1
(43) Pub. Date: May 19, 2016

(54) DELTA PATCH PROCESS

(71) Applicants: Martin Pospischil, Heidelberg (DE); Dimitrij Afonitschkin, Eppingen-Richen (DE); Iwan Zarembo, Reilingen (DE); Clemens Fehr, Hockenheim (DE); Rainer Himmeroeder, Ölsen (DE); Xinlei Feng, Rauenberg (DE)

(72) Inventors: Martin Pospischil, Heidelberg (DE); Dimitrij Afonitschkin, Eppingen-Richen (DE); Iwan Zarembo, Reilingen (DE); Clemens Fehr, Hockenheim (DE); Rainer Himmeroeder, Ölsen (DE); Xinlei Feng, Rauenberg (DE)

(21) Appl. No.: 14/540,223

(22) Filed: Nov. 13, 2014

(51) Int. Cl. G06F 9/445; G06F 9/44

(52) U.S. Cl. CPC G06F 8/65; G06F 8/71

(57) ABSTRACT

The present disclosure describes methods, systems, and computer program products for providing a delta patch process. One computer-implemented method includes receiving, from a customer site, a request for a software patch, wherein the request comprises a note number and a customer software component version, wherein the customer software component version includes a customer workspace globally unique identifier (GUID) and a customer integration sequence number (ISN), selecting a correction package (CP) based on the note number and the customer workspace GUID, wherein the CP comprises a maximum ISN, determining that the CP is uncontained in the customer software component version based on the maximum ISN and the customer software component version, and transmitting, to the customer site, the uncontained CP.

### BACKGROUND

In a software development environment, a software provider may develop a generic application and deliver the general application to a customer. The customer may customize the application at a customer site. Examples of such software development environment may include, for example, the SAP NETWEAVER Development Infrastructure (NWDI), which is a JAVA development environment, or some other software development environment, including combinations of software development environments. In some cases, the development objects of an application may be stored as a binary large object (BLOB) in the database. As a consequence, versions of files are stored with their complete content and are not characterized by their differences with regard to other versions.

In current software patch (SP) delivery systems, a software provider may deliver a SP of the generic application to a customer on a software component (SC) level, i.e., all development objects contained in their respective workspace are redelivered in their respective versions. At the customer site, the customer may be forced to implement all fixes that the software provider has provided between the customer's version of the application and the current SP's version. Furthermore, the customers may have to manually merge the content of the files that have been modified concurrently. Therefore, the customers may have to re-test large parts, if not the entire application, which can be time consuming, resource intensive, expensive, etc. The application testing can also result in lost business opportunities, user inconvenience, unavailable application functionality, loss of revenue, and/or the like.

### SUMMARY

The present disclosure relates to computer-implemented methods, computer-readable media, and computer systems for providing a delta patch process. One computer-implemented method includes receiving, from a customer site, a request for a software patch (SP), wherein the update request comprises a note number and a customer software component version, wherein the customer software component version (i.e., a customer's code version) includes a customer workspace globally unique identifier (GUID) and a customer integration sequence number (ISN), selecting a correction package (CP) based on the note number and the customer workspace GUID, wherein the CP comprises a maximum ISN, determining that the CP is uncontained in the customer software component version based on the maximum ISN and the customer software component version, and transmitting, to the customer site, the uncontained CP.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, comprising: comparing the maximum ISN with the customer ISN of the customer software component version, and if the maximum ISN is higher than the customer ISN of the customer software component version, determining that the CP is uncontained in the customer software component version.

A second aspect, combinable with any of the previous aspects, wherein the CP further comprises a minimum supported ISN, the method further comprising: determining whether the customer ISN is lower than the minimum supported ISN, and if the customer ISN is lower than the minimum supported ISN of the CP, returning, to the client site, an error message

A third aspect, combinable with any of the previous aspects, wherein the CP further comprises a predecessor CP, the method further comprising: determining that the predecessor CP is uncontained in the customer software component version, wherein the predecessor CP comprises a second predecessor CP of the predecessor CP, recursively determining that the second predecessor CP is uncontained in the customer software component version, and transmitting, to the client site, the uncontained predecessor CP and the second predecessor CP.

A fourth aspect, combinable with any of the previous aspects, wherein the CP further comprises a unified diff file, wherein the unified diff file comprises a difference between a current and a previous version of a software file.

A fifth aspect, combinable with any of the previous aspects, wherein the CP further comprises a path of a deleted file.

A sixth aspect, combinable with any of the previous aspects, wherein the SP operates in a JAVA development environment.

The subject matter described in this specification can be implemented in particular implementations so as to realize one or more of the following advantages. First, delivering delta batch according to the methods and systems described herein may enable a workflow that computes and automatically downloads required predecessor fixes, checks the list against already applied fixes, and provides a semi-automatic wizard for the application of the remaining ones. Second, the customers can distinguish the changes made to each fix and can pick the isolated fixes that they prefer to apply instead of updating the entire application. Third, the customers may reduce the manual merging of their customized changes to the application. Fourth, the customers may reduce the amount of re-testing that is required for each patch delivery and therefore reduces the application of new patches. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level architecture block diagram illustrating a delta patch system for implementing a delta patch process according to an implementation.

FIG. 2 is a flow diagram of method illustrating a preparation process for generating a Correction Package (CP) according to an implementation.

FIG. 3 is a flow diagram of method illustrating a testing process of a CP according to an implementation.

FIG. 4 is a flow diagram of method illustrating a validation process of a CP according to an implementation.

FIG. 5 is a flow diagram of method illustrating an application process of a CP according to an implementation.

FIG. 6 is a flow diagram of method illustrating a delta patch process according to an implementation.

FIG. 7 is a block diagram of an exemplary computer used in the delta batch process according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein can be applied to other implementations and applications without departing from the scope of the disclosure. Thus, the present disclosure is not intended to be limited to the described and/or illustrated implementations, but is to be accorded the widest scope consistent with the principles and features disclosed herein.

A software development environment, as used in this document, is an environment where a software application is developed and customized. In some cases, a software provider in the software development environment can develop a generic application and deliver the general application to a customer. The customer can receive the general application from the developer and then customize the application at a customer site. Examples of such a software development environment can include a NETWEAVER Development Infrastructure (NWDI), which is a JAVA development environment. In some cases, the development objects can be stored as a binary large object (BLOB) in the database. As a consequence, versions of files are stored with their complete content and are not characterized by their differences with regard to other versions.

A version management system of the software development environment can organize development in workspaces. Each workspace can be identified by a globally unique identifier (GUID). For each development object, a workspace holds a pointer to its active version. Therefore, the workspace represents a certain state of the development project. Changes to the workspace can be performed by integration of developer-created activities and/or propagation lists. Each integration into a workspace is labeled by a consecutive number, the Integration Sequence Number (ISN). Hence, a workspace GUID and its ISN represent a specific state of a development project. Examples of such version management system include the Design Time Repository (DTR).

In the current software patch (SP) delivery system, the software developer may deliver a SP of the generic application to the customers on software component (SC) level, e.g., all development objects contained in the respective DTR workspace are redelivered in their respective versions. At a customer site, the customer may be forced to implement all fixes that the software provider has provided between the customer's version of the application and the current SP's version. Furthermore, the customer may have to manually merge the content of the files that have been modified concurrently. Therefore, the customers may have to re-test large parts, if not the entire application, which is time consuming.

Note that the described software development environment and patch delivery system should not limit the described subject matter to the illustrated examples. In other possible implementations, there can be a specific system for the recreation, testing, delivering, and application of a SP implementing a delta between versions of software.

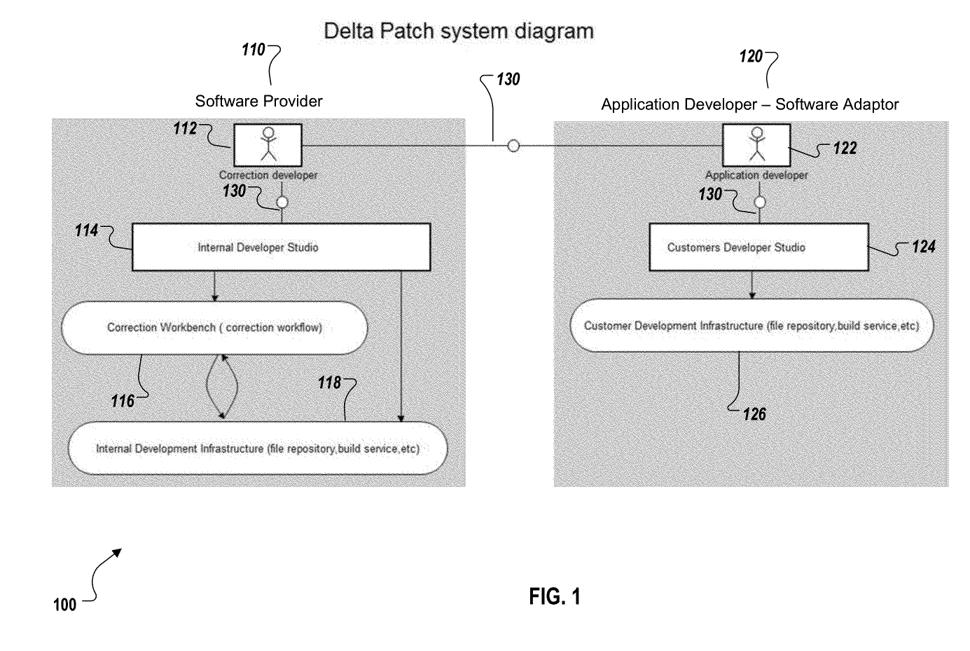

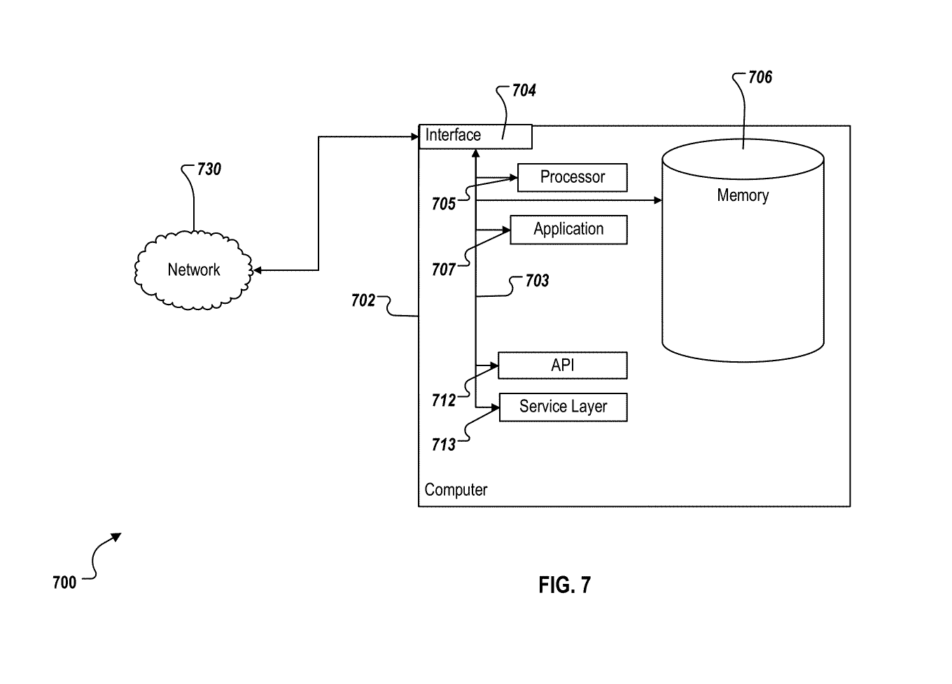

FIG. 1 is a high-level architecture block diagram illustrating a delta patch system 100 for implementing a delta patch process according to an implementation. At a high level, the illustrated delta patch system 100 includes or is made up of one or more communicably coupled computers (refer to FIG. 7) that communicate across a network 130 (note that although only three network 130 connections have been labeled in FIG. 1, one or more of the other indicated connections between components can also be considered part of network 130). In some implementations, the delta patch system 100 or portions of the delta patch system 100 can operate within a cloud-computing-based environment. The illustrated delta patch system 100 includes a software provider 110 that is communicably coupled with a software adapter 120 over the network 130. The described illustration is only one possible implementation of the described subject matter and is not intended to limit the disclosure to the single described implementation. Those of ordinary skill will appreciate the fact that the described components can be connected, combined, and used in alternative ways consistent with this disclosure.

The software provider 110 is any device or program that develops applications and delta patches for the applications. The software provider 110 includes a Correction Developer 112, an Internal Developer Studio 114, a Correction Workbench 116, and an Internal Development Infrastructure 118. The Correction Developer 112 is any person, device, or program that develops software fixes. The Internal Developer Studio 114 is an Integrated Development Environment (IDE) that develops applications. In some implementations, the IDE can be an ECLIPSE-based IDE. The Internal Developer Studio 114 can also include any program that can be used to create delta patches. The Correction Workbench 116 is a system that supports correction workflows. In some implementations, the Correction Workbench 116 can process problem messages, fix bugs, and/or transport codes to deliver delta patches. The Internal Development Infrastructure 118 is a collection of basic development infrastructure systems. These basic development infrastructure systems can include a file repository that is responsible for persisting codes, a build service that compiles, generates, and/or builds applications, a change management system that transports codes between different branches and the deployment of build results on applications, and a server and system landscape system that configures the development infrastructure.

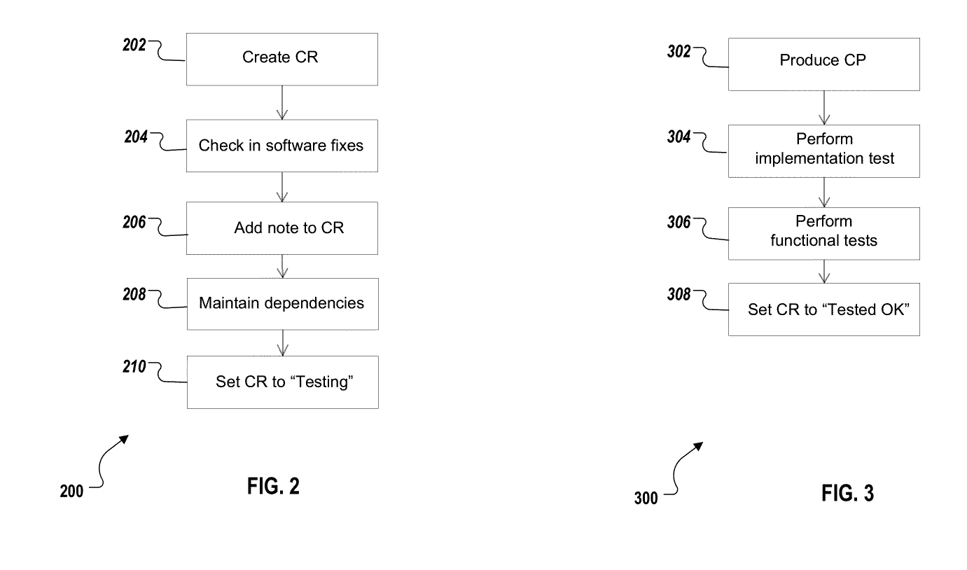

In operation, the Correction Developer 112 creates a software fix in the Internal Developer Studio 114. The software fix is passed to the Internal Development Infrastructure 118 to be built into the application for testing. If the software fix is successfully tested, the software fix is passed to the Correction Workbench 116 to be finalized into delta patches. The finalized delta patches are stored in the Internal Development Infrastructure 118. FIGS. 2-6 and associated descriptions provide details of the creation and testing process of a delta patch.

The software adapter 120 is any device or program that receives the applications and delta patches from the software provider 110 and applies the delta patches to the applications. The software adapter 120 includes an Application Developer 122, a Customer Developer Studio 124, and a Customer Development Infrastructure 126. The Application Developer 122 is any person, device, or program that requests and receives the delta patches. The Customer Developer Studio 124 is an Integrated Development Environment (IDE) that customizes applications. In some implementations, the IDE can be an ECLIPSE-based IDE. The Customer Developer Studio 124 can also include any program that can be used to apply delta patches. The Customer Development Infrastructure 126 is a collection of basic development infrastructure systems for customizing the applications. These basic development infrastructure systems can include a file repository that is responsible for persisting codes, a build service that compiles, generates, and builds customized applications, a change management system that transports codes between different branches and the deployment of build results on customized applications, and/or a server and system landscape system that configures the development infrastructure.

In operation, the Application Developer 122 requests and receives a delta patch. The Application Developer 122 applies the delta patch in the Customer Developer Studio 124. After the delta patch is applied, the Application Developer 122 uses the Customer Development Infrastructure 126 to build the customized application with the delta patch and store the customized application. FIGS. 2-6 and associated descriptions provide details of the application process of a delta patch.

FIG. 2 is a flow diagram of method 200 illustrating a preparation process for generating a Correction Package (CP) according to an implementation. The delta patch process uses CPs to construct and deliver SPs. For clarity of presentation, the description that follows generally describes method 200 in the context of FIGS. 1 and 3-7. However, it will be understood that method 200 can be performed, for example, by any other suitable system, environment, software, and hardware, or a combination of systems, environments, software, and hardware as appropriate. In some implementations, various steps of method 200 can be run in parallel, in combination, in loops, and/or in any order.

At 202, a Correction Request (CR) is created. The CR can be created by any persons or programs to modify the current version of an application. The objectives of the CR can include, e.g., correcting problems in the application, adding features to the application, or optimizing the performance of the application. The CR can be represented by a CR ID. In some implementations, the CR ID can be 24 digits. From 202, method 200 proceeds to 204.

At 204, software fixes are checked in. The software fixes are software codes that are developed to implement the CR. In some implementations, the software fixes can be developed by a software provider 110 in response to the CR. From 204, method 200 proceeds to 206.

At 206, a note is added to the CR. The note can include explanations of the software fixes that correspond to the CR. The explanations can include high-level descriptions of the software fixes. The note can be represented by a note number. From 206, method 200 proceeds to 208.

At 208, dependencies of the software fixes are maintained. The dependencies of the software fixes can be maintained by accounting for possible predecessor CPs that the current CR can depend on. In some implementations, the software provider 110 can determine a list of potential predecessor CPs based on files that are overlapped between the current CR and previous CRs. The software provider 110 can also search for additional potential predecessor CPs based on corrections made in the same software components or other developed software components in the same track. The software provider 110 can determine the predecessor CPs by deciding: 1) which of the proposed CRs are indeed predecessors and which ones aren't; and 2) which other (non-overlapping) CRs are predecessors. CRs for which there is no CP yet can be marked with a respective icon or decorator. From 208, method 200 proceeds to 210.

At 210, the CR is set to “Testing,” which indicates that the software fixes associated with the CR are ready for testing. After 210, method 200 stops.

FIG. 3 is a flow diagram of method 300 illustrating a testing process of a CP according to an implementation. For clarity of presentation, the description that follows generally describes method 300 in the context of FIGS. 1-2 and 4-7. However, it will be understood that method 300 can be performed, for example, by any other suitable system, environment, software, and hardware, or a combination of systems, environments, software, and hardware as appropriate. In some implementations, various steps of method 300 can be run in parallel, in combination, in loops, and/or in any order.

At 302, a CP is created. In some implementations, one CP is created in response to one CR. The software provider 110 can create CPs for respective CRs on demand at any time, e.g., for testing purposes or for pre-shipment to customers. The software provider 110 can use Internal ECLIPSE plugin in the Internal Developer Studio 114 to create CP. In some implementations, the name of the CP can comprise the corresponding CR ID, the note number, the export workspace (e.g., a cons/active—an active workspace of a consolidation system) GUID, and the minimum supported ISN. This approach may provide easy access to these parameters during dependency calculation.

A CP can include at least one of meta information, an exported propagation list that represents added files, the paths of files that are to be deleted, a unified diff file, or the entire content of files that are to be replaced (e.g., binaries).

The meta information can include at least one of the CR ID for the corresponding CR, the number of the note attached to the CR, the name/release/support package of the software component (SC), a globally unique ID of the SC's export workspace, a maximum integration sequence number (ISN), a list of direct predecessor CPs and their respective ISNs in their con/active workspace, or a minimum supported ISN. In some implementations, predecessor CPs can be represented by their respective CR IDs. In some cases, the meta-information can also include workspace GUIDs of the predecessor CPs if the predecessor CPs are from a different SC.

The maximum ISN represents the highest of all activities' ISNs in the export workspace. The ID of the export workspace and the maximum ISN provides a label for the propagation list of the workspace. A propagation list is a snapshot of the content of a workspace that is taken when creating an SCA (software component archive) for delivery to Service Market Place, which can be a central point where customers can download applications from the provider. The SCA (and thus the propagation list) represents an SP or patch of an SC and is imported at the customer site. It is therefore possible for the import wizard to read which propagation lists have been imported into the customer's project. The CP includes the workspace GUID and the ISN with which the integration of the fix in question into this workspace has been completed. Therefore, a cloud service can determine/evaluate whether the imported version already contains the fix.

The CP can include a minimum supported ISN. The minimum support ISN can indicate the oldest supported propagation list in order to limit the number of predecessors that are tracked. In some implementations, a supported interval can be defined. The application of a particular CP may not be possible if the latest SP update of the customer's project dates back longer than the predefined support interval. The supported interval can be defined based on amount of time, e.g., a business quarter, bi-annually, annually, etc. The supported interval can be extended or shortened depending on the particular development environment. In such a case, the minimum support ISN represents the beginning of the support interval.

The CP can include an exported propagation list that represents added files. For added files, it may not be sufficient to only ship the file content because the version management system may use globally unique IDs to identify file objects and their versions. Creating a file object with a certain content on the customer site would assign it a different ID than the one used at software provider. This in turn may create a name conflict once the Software Adapter at the customer site decides to apply a new SP. Including an exported propagation list that only contains the added files may enable the customer to import it into the version management system during patch application and thus create the files with the correct ID.

The CP can include paths for the deleted files instead of their object IDs. Customers may use different IDs due to false deletion and recreation of content, using the path as identifier accounts for such conflicts.

The CP can also include a unified diff file. The unified diff file can include the differences between the current and previous version of the files that have been changed. This approach enables the customer to consider changes done in all activities that are contained in the CR. In case a file has been changed in two or more activities, the base version during diff creation will be the direct predecessor of the file version contained in the first activity. The version that is diffed against the base in turn is taken from the latest activity in which it is contained.

The CP can also include the entire content of files that are to be replaced (e.g., binaries). In such a case, the CP can contain the new version of the file to be replaced. During the application of the delta patch, the content of the already existing file will be updated with the one contained in the CP. In the customer's version management system, a new version of the same object will be created.

When creating a CP for testing, the ISN of the export workspace may not be known. Also, the list of predecessor CPs may not be accurate. Hence, the CP at 302 can be tagged “preliminary.” If the preliminary CP is delivered to customer in a pre-shipment, the preliminary tag can also persist during the application of the preliminary CP at the customer site. Otherwise, the application of a released version of the CP can be rejected even though the released CP can have different content. For a similar reason, pre-shipped CPs can be purged before applying released CPs. From 302, method 300 proceeds to 304.

At 304, the implementation test of the CP is performed. The implementation test can be performed by the software provider 110 using the Internal Developer Studio 114. In some implementations, the Internal Developer Studio 114 can use ECLIPSE plugins. In some implementations, the implementation test includes the successive application of the CP's predecessor CPs and the CP itself to a predefined base version of the application. In some cases, the predefined base version is the oldest supported version of the application that is defined based on the support interval. Because overlapping CRs may be excluded by the software provider 110, the implementation test may not include the comparison between a file content's MD5 with a target file. Still, the successful build of the obtained code is a strong indication that the list of predecessor CPs is complete and the successive CP application is successful.

In some implementations, the implementation test can be performed automatically. For example, the implementation test can use a dedicated NWDI track that is accessible from the developer PC. The track configuration can be the same as the one for the development track for the respective release. The required archives can be imported. Before starting the test, the DTR workspaces, which can include both active and inactive workspaces, are deleted and recreated. Then, the propagation list representing the base version is imported to both workspaces. Eventually, all predecessor CPs and the tested CP itself are applied automatically to the inactive workspace. This application can happen in an automatic fashion without user interaction. In order to save time, the build in Component Build Service can take place once all CPs are applied. The expected result is successfully built archives that can be used for functional correctness tests. In case a runtime system is configured for the track, the archives will automatically be deployed. From 304, method 300 proceeds to 306.

At 306, the functional correction test of the CP is performed. The archives that result from the implementation test described above can be used for functional correctness tests. From 306, method 300 proceeds to 308.

At 308, the testing phase of the CP is completed and the CR is set to “Tested OK.” After 308, method 300 stops.

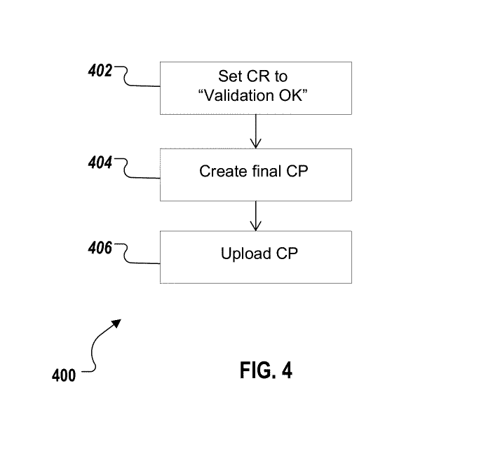

FIG. 4 is a flow diagram of method 400 illustrating a validation process for a CP according to an implementation. For clarity of presentation, the description that follows generally describes method 400 in the context of FIGS. 1-3 and 5-7. However, it will be understood that method 400 can be performed, for example, by any other suitable system, environment, software, and hardware, or a combination of systems, environments, software, and hardware as appropriate. In some implementations, various steps of method 200 can be run in parallel, in combination, in loops, and/or in any order.

At 402, the CR is set to “Validation OK.” From 402, method 400 proceeds to 404.

At 404, a final CP is created. When the testing is completed and the CR is set to ‘Validation OK,’ the ISN to the export workspace is known. Therefore, the final CP can include finalized dependencies of predecessor CPs. In some cases, the ECLIPSE plugin can be used to create the final CP. In some cases, authorization can be required to finalize the CP. From 404, method 400 proceeds to 406.

At 406, the final CP is uploaded. In some implementations, the final CP can be updated into a Document Service in a cloud service. The cloud service can include two parts. The first part is the Document Service, which can be used to store the final CPs. The second part is a servlet/service that receives and processes requests from the import wizard. In some implementations, the Document Service can be provided through a cloud-based computing platform (e.g., the HANA Cloud Platform (HCP)), where it can be accessed during patch application at a customer site. Since the CP is uploaded automatically and after the CR is released, the CP will have a well-defined state and will not come in different versions. If the fix for a particular CR is not sufficient, a second CR with the same note attached to it can be created. The predecessor check during application is based on CR numbers, and therefore the different note versions will not affect the patch process. After 406, method 400 stops.

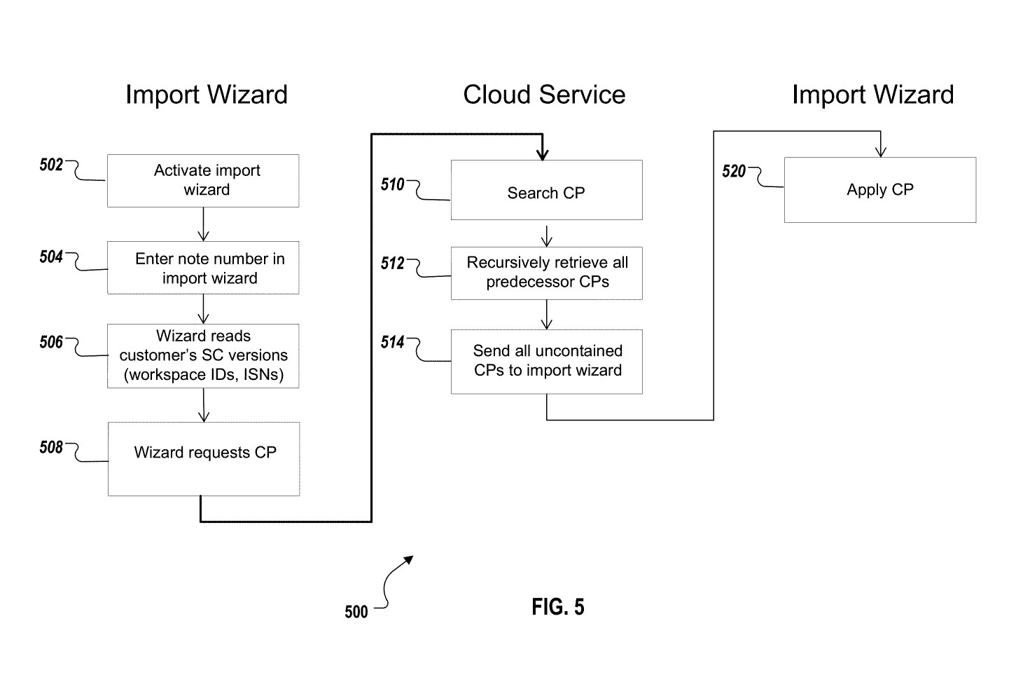

FIG. 5 is a flow diagram of method 500 illustrating an application process of a CP according to an implementation. For clarity of presentation, the description that follows generally describes method 500 in the context of FIGS. 1-4 and 6-7. However, it will be understood that method 500 can be performed, for example, by any other suitable system, environment, software, and hardware, or a combination of systems, environments, software, and hardware as appropriate. In some implementations, various steps of method 200 can be run in parallel, in combination, in loops, and/or in any order.

At 502, an import wizard is activated. The import wizard is any program or device in the software adapter 120 that a customer may use to request and apply the CP at the customer site. In some implementations, the import wizard can be implemented by enhancing an external ECLIPSE plugin. The import wizard can be activated from the context menu of a development configuration in the Customer Development Infrastructure 126. From 502, method 500 proceeds to 504.

At 504, a note number is entered. In some cases, the customer can enter the note number of the fix he wants to apply. In some implementations, the customer can also enter his credentials, e.g., customer number, S-user, or password to provide security verification information. From 504, method 500 proceeds to 506.

At 506, the import wizard reads the SC versions. In some implementations, the import wizard can scan the inactive workspaces of all SCs for the integrated propagation lists that correspond to SAP-created SCAs. In some implementations, the import wizard can search for propagation lists whose names start with “CMS” or have the property “CMS:cms-owned-proplist.” The first check can target the project's release, which can be determined by the workspace GUID from which the propagation list has been assembled. This ID can be the value of the property “CMS:cms-owned-proplist” and can also be encoded in the propagation list's name. In addition, as a crosscheck, the import wizard can determine if the resource ‘/knownws/<workspaceID>’ exists. If the resource exists, then the propagation list has not been created in the customer's repository. If the resource does not exist, then the import wizard can exclude propagation lists that have been created in the customer's DTR.

Further, the import wizard examines the SC versions that the propagation lists represent. An SC version includes an ISN and workspace GUID of the SC. The ISN can represent the highest ISN of the workspace from which the propagation list has been assembled at the time of creation. The scope of the propagation list is encoded in the property ‘XCM:creation-history,’ which can be in the format of ‘[AddIsnRange(isnFrom=1, isnTo=<ISN>)].’ From 506, method 500 proceeds to 508.

At 508, the import wizard sends a request to the cloud service to request a CP corresponding to the note number received at 504 and all predecessor CPs. The request can include customer SC versions of the SCs collected at 506. The customer SC versions can include the workspace GUIDs and the ISNs for the customer SCs. The request can also include the credentials received at 504. From 508, method 500 proceeds to 510.

At 510, the cloud service receives the request from the import wizard and searches CPs based on the note number. As described above, the request from the import wizard can be received and processed by the servlet/service of the cloud service. The cloud service searches the Document Service for one or several CPs that are relevant to the note number and workspaces IDs included in the request. From 510, method 500 proceeds to 512.

At 512, the cloud service identifies at least one CP that matches the request and recursively retrieves all predecessor CPs of the identified CP. In some implementations, the cloud service can compare the minimum supported ISN of the identified CP with the customer SC versions included in the request. If the ISN of the customer SC version is lower than the minimum supported ISN in the identified CP, then the cloud service can cancel the patch application process and send an appropriate error to the import wizard. If the ISN of the customer SC version is equal to or higher than the minimum supported ISN in the identified CP, the cloud service can continue the patch application process.

The cloud service can use the maximum ISN of the identified CP to determine whether the identified CP is contained in the customer SC version. For example, if the maximum ISN is higher than the ISN in the customer SC version, then the cloud can determine that the identified CP is uncontained in the customer SC version and would be delivered in the patch. If the maximum ISN is lower than or equal to the ISN in the customer SC version, then the cloud can determine that the identified CP is contained in the customer SC version and would not be delivered in the patch.

If the identified CP is uncontained in the customer SC version, the cloud service can determine whether a predecessor CP of the identified CP is contained in the customer SC version. The cloud service can use the maximum ISN of the predecessor CP to determine whether the predecessor CP is contained using the similar method as described above. The cloud service can search all predecessor CPs of the identified CP and recursively search all predecessor CPs of the uncontained predecessor CPs. The cloud service can repeat this step for all predecessor CPs that are relevant to the customer SC version. From 512, method 500 proceeds to 514.

At 514, the cloud service collects all the uncontained CPs and sends them to the import wizard. In some implementations, the cloud service can compress the uncontained CPs in, e.g., a zip-archive, before sending to the import wizard. From 514, method 500 proceeds to 520.

At 520, the import wizard applies the received CPs at customer site. The import wizard can apply the CPs in order. For example, the import wizard can trigger the application from the CP with the lowest ISN to the highest ISN. To apply a CP, in some implementations, the wizard first looks for all activities in all inactive workspaces that have the custom property “DELTA_PATCH:patch-id.” The existence of this property can indicate that this activity corresponds to the application of a CP. The value of this property can indicate the ID of the CP. The important wizard can go through the list of activities with this property to determine if 1) the CP has not yet been applied, and 2) all required predecessors of the CP have already been applied. In addition, the import wizard checks the SC versions of the CP to determine whether predecessor dependencies have already been covered. If a predecessor CP is missing, the import wizard can exit the application process of the CP. In some cases, the predecessor check may not apply to pre-shipped CPs.

If all predecessor CPs are implemented, the import wizard imports the propagation list of added files. The import wizard can then create a new activity to handle all other changes. Changed lines can be applied using ECLIPSE's ‘Apply Patch’ API, which involves a graphical comparison of the current and the patched file versions. The customer can check and alter the file content if necessary.

Once all changes are applied, the customer can check-in the activity (e.g., it may be necessary to apply changes to automatically merged files and the customer is permitted to decides when to check-in the activity). Upon check-in, the import wizard can check that no other files except the expected ones are contained in the activity. The import wizard can create the “DELTA_PATCH:patch-id” property and set its value to match the ID of the applied CP. This concludes the application of a CP, and the import wizard can continue to apply the next CP.

Under certain conditions, e.g., if tests are failing, a customer may want to revert back to the state before applying a CP, i.e., to undo the changes that are applied with the respective activity to some workspace. Technically, DTR cannot undo the integration of activities. Instead, new versions of the involved files that have the same content as the versions from before the activity was checked in can be created. If the “purged” activity is not the latest integration into this workspace, by purging only this one activity, the project can potentially become inconsistent. Hence, the import wizard can implement a ‘purge’ activity in four flavors, depending on how to handle the case for which the purged activity is not the latest integration:
1) Purge all subsequent activities as well. This is a clean solution, but it may purge much more than what is intended.
2) Purge the subsequent activities that overlap directly or indirectly. This potentially reduces the changed code, but may not guarantee a consistent project after purge.
3) Only purge the intended activity. This leaves the responsibility to resolve inconsistency with the customer.
4). Forbid the purge. This is also a clean solution, but it may render the feature useless.

In some cases, option 3 is preferred because the customer may have the knowledge to resolve the inconsistency. Proper documentation can maintain the awareness of the purge activities.

When purging the application of a CP, the import wizard can keep track of the property ‘DELTA_PATCH:patch-id’ of the purged activity. Hence, when the purged activity has this property, the purge activity can get the property with the same value supplemented by a minus sign. This indicates that the CP is purged.

2) After a CP is applied, predecessor CPs of the applied CP may not be purged. This can be achieved if the import wizard only purges the activity that corresponds to latest applied CP.

It may be useful to quickly get an overview of all CPs that have been applied. In some implementations, the import wizard can evaluate all activities with property ‘DELTA_PATCH:patch-id’ and display their current status. The import wizard can also present a ‘purge’ button next to the latest applied CP to enable a customer to initiate a purge activity. After 520, method 500 stops.

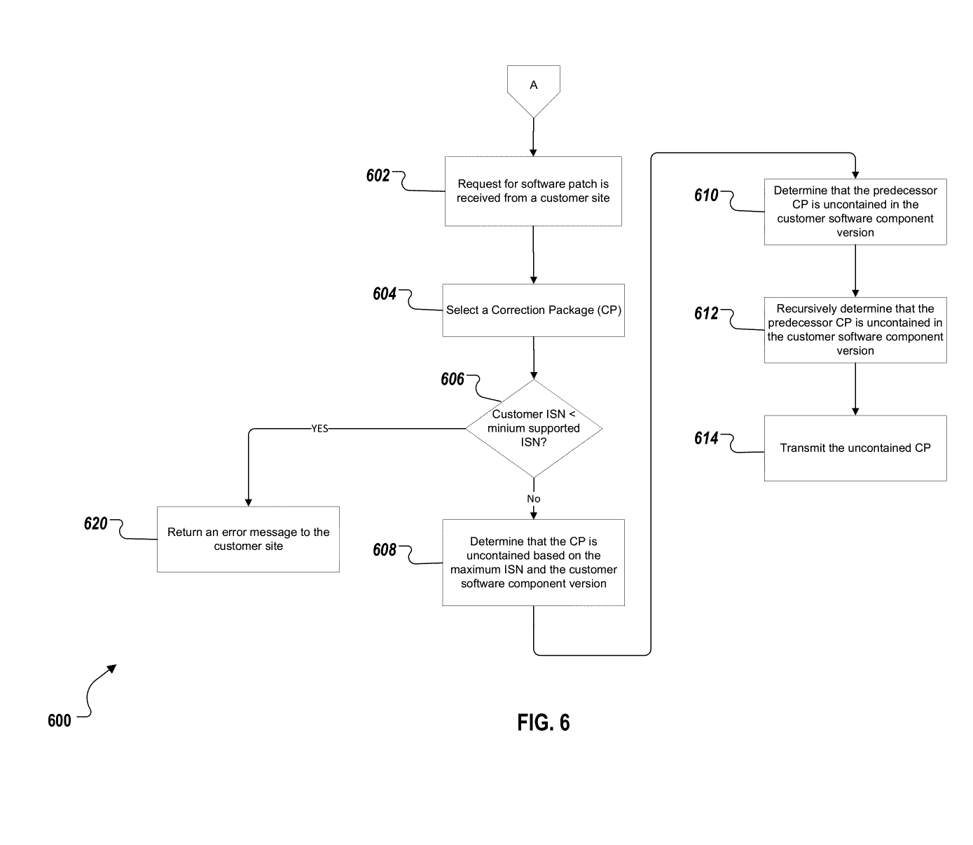

FIG. 6 is a flow diagram of method 600 illustrating a delta patch process according to an implementation. For clarity of presentation, the description that follows generally describes method 600 in the context of FIGS. 1-5 and 7. However, it will be understood that method 600 can be performed, for example, by any other suitable system, environment, software, and hardware, or a combination of systems, environments, software, and hardware as appropriate. In some implementations, various steps of method 600 can be run in parallel, in combination, in loops, and/or in any order.

At 602, a request for a SP is received from a customer site. The request comprises a note number and a customer software component version. The customer software component version includes a customer workspace GUID and a customer integration sequence number (ISN). In some implementations, the SP operates in a JAVA development environment. From 602, method 600 proceeds to 604.

At 604, a CP is selected based on the note number and the customer workspace GUID. The CP can comprise a maximum ISN. In some implementations, the CP can also comprise a minimum supported ISN, a predecessor CP, a unified diff file that comprises a difference between a current and a previous version of a software file, or a path of a deleted file. From 604, method 600 proceeds to 606.

At 606, the customer ISN is compared to the minimum supported ISN. If the customer ISN is lower than the minimum supported ISN of the CP, at 620, an error message is returned to the customer site and the process terminates. If the customer ISN is higher than or equal to the minimum supported ISN of the CP, method 600 proceeds to 608.

At 608, the CP is determined to be uncontained in the customer software component version based on the maximum ISN and the customer software component version. In some implementations, the determination is performed by comparing the maximum ISN with the customer ISN of the customer software component version. If the maximum ISN is higher than the customer ISN of the customer software component version, CP is determined to be uncontained in the customer software component version. If the maximum ISN is lower than and equal to the customer ISN of the customer software component version, the CP is determined to be contained in the customer software component version and will not be delivered. From 608, method 600 proceeds to 610.

At 610, the predecessor CP is determined to be uncontained in the customer software component version. In some implementations, the predecessor CP comprises a second predecessor CP of the predecessor CP. From 610, method 600 proceeds to 614 if there is not a second predecessor CP. If there is a second predecessor CP, at 612, the second predecessor CP is recursively determined to be uncontained in the customer software component version. This process repeats until all uncontained predecessor CPs are determined. From 612, method 600 proceeds to 614.

At 614, the uncontained CP is transmitted to the customer site. In some implementations, the uncontained predecessor CP and the uncontained second predecessor CP are transmitted to the customer site. After 614, method 600 stops.

FIG. 7 is a block diagram 700 of an exemplary computer used in the delta batch process according to an implementation. The illustrated computer 702 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 702 may comprise a computer that includes an input device, such as a keypad, keyboard, touch screen, or other device that can accept user information, and an output device that conveys information associated with the operation of the computer 702, including digital data, visual and/or audio information, or a GUI.

The computer 702 can serve as a client (e.g., the software adapter 120), network component, a server, a database or other persistency, and/or any other component of the delta patch system 100. The illustrated computer 702 is communicably coupled with a network 730 (e.g., network 130). In some implementations, one or more components of the computer 702 may be configured to operate within a cloud-computing-based environment.

At a high level, the computer 702 is an electronic computing device operable to receive, transmit, process, store, or manage data and information associated with the delta patch system 100. According to some implementations, the computer 702 may also include or be communicably coupled with an application server, e-mail server, web server, caching server, streaming data server, business intelligence (BI) server, and/or other server.

The computer 702 can receive requests over network 730 from a client application (e.g., executing on another computer 702) and respond to the received requests by processing the said requests in an appropriate software application. In addition, requests may also be sent to the computer 702 from internal users (e.g., from a command console or by another appropriate access method), external or third parties, other automated applications, as well as any other appropriate entities, individuals, systems, or computers.

Each of the components of the computer 702 can communicate using a system bus 703. In some implementations, any and/or all the components of the computer 702, both hardware and/or software, may interface with each other and/or the interface 704 over the system bus 703 using an application programming interface (API) 712 and/or a service layer 713. The API 712 may include specifications for routines, data structures, and object classes. The API 712 may be either computer-language independent or dependent and refer to a complete interface, a single function, or even a set of APIs. The service layer 713 provides software services to the computer 702 and/or the delta patch system 100. The functionality of the computer 702 may be accessible for all service consumers using this service layer. Software services, such as those provided by the service layer 713, provide reusable, defined business functionalities through a defined interface. For example, the interface may be software written in JAVA, C++, or other suitable language providing data in extensible markup language (XML) format or other suitable format. While illustrated as an integrated component of the computer 702, alternative implementations may illustrate the API 712 and/or the service layer 713 as stand-alone components in relation to other components of the computer 702 and/or delta patch system 100. Moreover, any or all parts of the API 712 and/or the service layer 713 may be implemented as child or sub-modules of another software module, enterprise application, or hardware module without departing from the scope of this disclosure.

The computer 702 includes an interface 704. Although illustrated as a single interface 704 in FIG. 7, two or more interfaces 704 may be used according to particular needs, desires, or particular implementations of the computer 702 and/or delta patch system 100. The interface 704 is used by the computer 702 for communicating with other systems in a distributed environment—including within the delta patch system 100—connected to the network 730 (whether illustrated or not). Generally, the interface 704 comprises logic encoded in software and/or hardware in a suitable combination and operable to communicate with the network 730. More specifically, the interface 704 may comprise software supporting one or more communication protocols associated with communications such that the network 730 or interface's hardware is operable to communicate physical signals within and outside of the illustrated delta patch system 100.

The computer 702 includes a processor 705. Although illustrated as a single processor 705 in FIG. 7, two or more processors may be used according to particular needs, desires, or particular implementations of the computer 702 and/or the delta patch system 100. Generally, the processor 705 executes instructions and manipulates data to perform the operations of the computer 702. Specifically, the processor 705 executes the functionality required for providing a delta patch process

The computer 702 also includes a memory 706 that holds data for the computer 702 and/or other components of the delta patch system 100. Although illustrated as a single memory 706 in FIG. 7, two or more memories may be used according to particular needs, desires, or particular implementations of the computer 702 and/or the delta patch system 100. While memory 706 is illustrated as an integral component of the computer 702, in alternative implementations, memory 706 can be external to the computer 702 and/or the delta patch system 100.

The application 707 is an algorithmic software engine providing functionality according to particular needs, desires, or particular implementations of the computer 702 and/or the delta patch system 100, particularly with respect to functionality required for providing a delta patch process. For example, application 707 can serve as one or more components/applications described in FIGS. 1-6. Further, although illustrated as a single application 707, the application 707 may be implemented as multiple applications 707 on the computer 702. In addition, although illustrated as integral to the computer 702, in alternative implementations, the application 707 can be external to the computer 702 and/or the delta patch system 100.

There may be any number of computers 702 associated with, or external to, the delta patch system 100 and communicating over network 730. Further, the term “client,” “user,” and other appropriate terminology may be used interchangeably as appropriate without departing from the scope of this disclosure. Moreover, this disclosure contemplates that many users may use one computer 702, or that one user may use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic disks, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media, and memory devices, including by way of example, semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user, and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language-independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A method, comprising:
receiving, from a customer site, a request for a software patch, wherein the request comprises both a note number identifying a note including explanations of software fixes corresponding to the request and high-level descriptions of the software fixes and a customer software component version, wherein the customer software component version includes both a customer workspace globally unique identifier (GUID) and a customer integration sequence number (ISN) representing each particular integration of developer-created activities or propagation lists, wherein the GUID and the ISN represent together a specific state of a software development project;
selecting a correction package (CP) based on the note number and the customer workspace GUID, wherein the CP comprises a maximum ISN;
determining that the CP is uncontained in the customer software component version based on the maximum ISN and the customer software component version; and
transmitting, to the customer site, the uncontained CP.

2. The method of claim 1, wherein the determining further comprises:
comparing the maximum ISN with the customer ISN of the customer software component version; and
if the maximum ISN is higher than the customer ISN of the customer software component version, determining that the CP is uncontained in the customer software component version.

3. The method of claim 1, wherein the CP further comprises a minimum supported ISN, the method further comprising:
determining whether the customer ISN is lower than the minimum supported ISN; and
if the customer ISN is lower than the minimum supported ISN of the CP, returning, to the customer site, an error message.

4. The method of claim 1, wherein the CP further comprises a predecessor CP, the method further comprising:
determining that the predecessor CP is uncontained in the customer software component version; wherein the predecessor CP comprises a second predecessor CP of the predecessor CP;
recursively determining that the second predecessor CP is uncontained in the customer software component version; and
transmitting, to the customer site, the uncontained predecessor CP and the uncontained second predecessor CP.

5. The method of claim 1, wherein the CP further comprises a unified diff file, wherein the unified diff file comprises a difference between a current and a previous version of a software file.

6. The method of claim 1, wherein the CP further comprises a path of a deleted file.

7. The method of claim 1, wherein the software patch operates in a JAVA development environment.

8. A system, comprising:
a memory;
at least one hardware processor interoperably coupled with the memory and configured to:
receive, from a customer site, a request for a software patch, wherein the request comprises both a note number identifying a note including explanations of software fixes corresponding to the request and high-level descriptions of the software fixes and a customer software component version, wherein the customer software component version includes both a customer workspace globally unique identifier (GUID) and a customer integration sequence number (ISN) representing each particular integration of developer-created activities or propagation lists, wherein the GUID and the ISN represent together a specific state of a software development project;
select a correction package (CP) based on the note number and the customer workspace GUID, wherein the CP comprises a maximum ISN;
determine that the CP is uncontained in the customer software component version based on the maximum ISN and the customer software component version; and
transmit to the customer site, the uncontained CP.

9. The system of claim 8, wherein the determining further comprises:
comparing the maximum ISN with the customer ISN of the customer software component version; and
if the maximum ISN is higher than the customer ISN of the customer software component version, determining that the CP is uncontained in the customer software component version.

10. The system of claim 8, wherein the CP further comprises a minimum supported ISN, the at least one hardware processor further configure to:
determine whether the customer ISN is lower than the minimum supported ISN; and
if the customer ISN is lower than the minimum supported ISN of the CP, returning, to the customer site, an error message.

11. The system of claim 8, wherein the CP further comprises a predecessor CP, the at least one hardware processor further configure to:
determine that the predecessor CP is uncontained in the customer software component version; wherein the predecessor CP comprises a second predecessor CP of the predecessor CP;
recursively determine that the second predecessor CP is uncontained in the customer software component version; and
transmit, to the customer site, the uncontained predecessor CP and the uncontained second predecessor CP.

12. The system of claim 8, wherein the CP further comprises a unified diff file or a patch of a deleted file, wherein the unified diff file comprises a difference between a current and a previous version of a software file.

13. The system of claim 8, wherein the software patch operates in a JAVA development environment.

14. A non-transitory, computer-readable medium storing computer-readable instructions for providing a delta patch process, the instructions executable by a computer and configured to:
receive, from a customer site, a request for a software patch, wherein the request comprises both a note number identifying a note including explanations of software fixes corresponding to the request and high-level descriptions of the software fixes and a customer software component version, wherein the customer software component version includes both a customer workspace globally unique identifier (GUID) and a customer integration sequence number (ISN) representing each particular integration of developer-created activities or propagation lists, wherein the GUID and the ISN represent together a specific state of a software development project;
select a correction package (CP) based on the note number and the customer workspace GUID, wherein the CP comprises a maximum ISN;
determine that the CP is uncontained in the customer software component version based on the maximum ISN and the customer software component version; and
transmit to the customer site, the uncontained CP.

15. The non-transitory, computer-readable medium of claim 14, wherein the determining further comprises:
comparing the maximum ISN with the customer ISN of the customer software component version; and
if the maximum ISN is higher than the customer ISN of the customer software component version, determining that the CP is uncontained in the customer software component version.

16. The non-transitory, computer-readable medium of claim 14, wherein the CP further comprises a minimum supported ISN, the instructions further configure to:
determine whether the customer ISN is lower than the minimum supported ISN; and
if the customer ISN is lower than the minimum supported ISN of the CP, returning, to the customer site, an error message.

17. The non-transitory, computer-readable medium of claim 14, wherein the CP further comprises a predecessor CP, the instructions further configure to:
determine that the predecessor CP is uncontained in the customer software component version; wherein the predecessor CP comprises a second predecessor CP of the predecessor CP;
recursively determine that the second predecessor CP is uncontained in the customer software component version; and
transmit, to the customer site, the uncontained predecessor CP and the uncontained second predecessor CP.

18. The non-transitory, computer-readable medium of claim 14, wherein the CP further comprises a unified diff file, wherein the unified diff file comprises a difference between a current and a previous version of a software file.

19. The non-transitory, computer-readable medium of claim 14, wherein the CP further comprises a path of a deleted file.

20. The non-transitory, computer-readable medium of claim 14, wherein the software patch operates in a JAVA development environment.
